(19) United States
(12) Patent Application Publication
(10) Pub. No.: US 2026/0142381 A1
(43) Pub. Date: May 21, 2026

(54) HIGH-FREQUENCY DIFFUSION SHEET

(71) Applicant: SUMITOMO BAKELITE CO., LTD., Shinagawa-ku, Tokyo (JP)

(72) Inventors: Toshiaki Watanabe, Tokyo (JP); Takeshi Hosomi, Tokyo (JP); Mizuki Numayama, Tokyo (JP)

(21) Appl. No.: 19/113,446

(22) PCT Filed: Sep. 22, 2023
(86) PCT No.: PCT/JP2023/034590

§ 371 Date: Mar. 20, 2025

(30) Foreign Application Priority Data
Sep. 26, 2022 (JP) 2022-153140

(51) Int. Cl. H01Q 15/23; H01Q 1/52; H01Q 9/00

(52) U.S. Cl. CPC H01Q 15/23; H01Q 1/526; H01Q 9/00

(57) ABSTRACT

An object of the present invention is to provide a high-frequency diffusion sheet capable of increasing the opportunity to receive electromagnetic waves in a high frequency range by a communication device inside a building by reflecting and diffusing the electromagnetic waves in the high frequency range. A high-frequency diffusion sheet 10 of the present invention is used for diffusing electromagnetic waves in a high frequency range, and is configured with a laminate having an electromagnetic wave shielding layer 11 that has electromagnetic wave shielding properties, and an electromagnetic wave reflection layer 13 that is laminated on the electromagnetic wave shielding layer 11 and has electromagnetic wave reflectivity, and the electromagnetic wave shielding layer 11 is patterned in a plan view of the laminate, and has an opening portion 15 penetrating the electromagnetic wave shielding layer 11 in a thickness direction.

### TECHNICAL FIELD

The present invention relates to a high-frequency diffusion sheet.

### BACKGROUND ART

In recent years, with the increase in speed and capacity of communication devices such as mobile phones, smartphones, tablets, and mobile personal computers, electromagnetic waves in a high frequency range of equal to or more than 1 GHz and equal to or less than 80 GHz have been proposed to be used as the electromagnetic waves (electromagnetic signals) received by these communication devices (refer to Patent Document 1, for example).

Electromagnetic waves in such a high frequency range have higher straightness (directivity) as compared to electromagnetic waves in a low frequency range. Therefore, an opportunity to receive electromagnetic waves by a communication device is also low for the electromagnetic waves in the low frequency range.

Accordingly, in a case where electromagnetic waves are received by a communication device inside a building, it is desirable that electromagnetic waves having high straightness are reflected and diffused, that is, diffracted without being absorbed by colliding with a wall portion or the like of the building before the electromagnetic waves are transmitted through a transmission region, such as a window portion, through which the electromagnetic waves are allowed to be transmitted, and an opportunity to pass through the passage region is obtained again. Further, after the electromagnetic waves having high straightness are transmitted through the transmission region and can be introduced into the building, it is desired that the electromagnetic waves can be reflected and diffused, that is, diffracted in wall portions, curtains, and the like inside the building in order to increase the opportunity to receive the electromagnetic waves by the communication device inside the building.

### CITATION LIST

### Patent Literature

[PTL 1] Japanese Laid-Open Patent Publication No. 2012-190920

### SUMMARY OF INVENTION

### Technical Problem

An object of the present invention is to provide a high-frequency diffusion sheet capable of increasing an opportunity to receive electromagnetic waves in a high frequency range by a communication device inside a building by reflecting and diffusing the electromagnetic waves in the high frequency range.

### Solution to Problem

Such an object is achieved by the present invention described in the following (1) to (12).
(1) A high-frequency diffusion sheet that is used for diffusing electromagnetic waves in a high frequency range, the high-frequency diffusion sheet including: a laminate having an electromagnetic wave shielding layer that has electromagnetic wave shielding properties, and an electromagnetic wave reflection layer that is laminated on the electromagnetic wave shielding layer and has electromagnetic wave reflectivity,
in which the electromagnetic wave shielding layer is patterned in a plan view of the laminate, and has an opening portion penetrating the electromagnetic wave shielding layer in a thickness direction.
(2) The high-frequency diffusion sheet according to (1), in which the electromagnetic wave shielding layer shields the electromagnetic waves by reflecting or absorbing the electromagnetic waves.
(3) The high-frequency diffusion sheet according to (2), in which both the electromagnetic wave shielding layer and the electromagnetic wave reflection layer are thin metal film layers or metal powder-containing adhesive layers configured to contain a metal powder and a binder resin.
(4) The high-frequency diffusion sheet according to any one of (1) to (3), in which the laminate further has a resin sheet having transparency, and the resin sheet is laminated between the electromagnetic wave shielding layer and the electromagnetic wave reflection layer, on a side of the electromagnetic wave shielding layer opposite to the electromagnetic wave reflection layer, or on a side of the electromagnetic wave reflection layer opposite to the electromagnetic wave shielding layer.
(5) The high-frequency diffusion sheet according to any one of (1) to (4), in which the high-frequency diffusion sheet is configured such that the electromagnetic waves are diffused by being diffracted by the opening portion when the electromagnetic waves reflected by the electromagnetic wave reflection layer pass through the electromagnetic wave shielding layer.
(6) The high-frequency diffusion sheet according to any one of (1) to (5), in which when W [mm] is an average width of the opening portion and λ [mm] is a wavelength of the electromagnetic waves, W/λ is equal to or less than 1.0.
(7) The high-frequency diffusion sheet according to any one of (1) to (6), in which an average thickness T1 of the electromagnetic wave shielding layer is equal to or more than 0.05 μm and equal to or less than 70.0 μm.
(8) The high-frequency diffusion sheet according to any one of (1) to (7), in which an average thickness T2 of the electromagnetic wave reflection layer is equal to or more than 0.05 μm and equal or less than 70.0 μm.
(9) The high-frequency diffusion sheet according to any one of (1) to (8), in which a frequency of the electromagnetic waves is equal to or more than 1 GHZ and equal to or less than 80 GHZ.
(10) The high-frequency diffusion sheet according to any one of (1) to (9), in which the high-frequency diffusion sheet is used by being attached to at least one of an inside and an outside of a building.
(11) The high-frequency diffusion sheet according to any one of (1) to (10), in which the electromagnetic wave reflection layer has a plurality of through-holes penetrating the electromagnetic wave reflection layer in the thickness direction, and an opening ratio of the electromagnetic wave reflection layer is 80% to 95%.
(12) The high-frequency diffusion sheet according to (11), in which when λ [mm] is a wavelength of the electromagnetic waves, a width of the through-hole is equal to or less than λ/10 [mm].

### Advantageous Effects of Invention

According to the high-frequency diffusion sheet of the present invention, when electromagnetic waves in a high frequency range are reflected, the electromagnetic waves can be reliably diffused by being diffracted in the opening portion of the electromagnetic wave shielding layer of the high-frequency diffusion sheet.

Therefore, in a case where electromagnetic waves are received by a communication device inside a building (building structure), the high-frequency diffusion sheet according to the present invention is attached to a wall portion or the like of the building before the electromagnetic waves in the high frequency range are transmitted through a transmission region through which the electromagnetic waves are allowed to be transmitted, such as a window portion provided in the building. As a result, since the electromagnetic waves are reflected and diffused, that is, diffracted, without being absorbed by colliding with the wall portion or the like, the electromagnetic waves have another opportunity to pass through the passage region.

Further, after the electromagnetic waves in the high frequency range are transmitted through the transmission region and are introduced into the building, the high-frequency diffusion sheet according to the present invention is attached to the wall portions, the curtains, or the like in the building. As a result, in these wall portions, curtains, and the like, the electromagnetic waves can be reflected and diffused, that is, diffracted.

This enables a communication device to favorably receive the electromagnetic waves in a wide range inside a building.

### BRIEF DESCRIPTION OF DRAWINGS

FIG. 1 is a plan view showing a first embodiment of a high-frequency diffusion sheet of the present invention.

FIG. 2 is a cross-sectional view taken along the line A-A shown in FIG. 1.

FIG. 3 is a plan view showing another configuration of opening portions in an electromagnetic wave shielding layer of the high-frequency diffusion sheet in FIG. 1.

FIGS. 4A and 4B are plan views showing a second embodiment of the high-frequency diffusion sheet of the present invention.

FIG. 5 is a longitudinal cross-sectional view showing a third embodiment of the high-frequency diffusion sheet of the present invention.

FIGS. 6A and 6B are diagrams showing a test sample used for evaluation of diffraction of electromagnetic waves (FIG. 6A being a plan view, and FIG. 6B being a cross-sectional view taken along the line B-B in FIG. 6A).

### DESCRIPTION OF EMBODIMENTS

Hereinbelow, a high-frequency diffusion sheet of the present invention will be described in detail based on suitable embodiments shown in the accompanying drawings.

### <High-Frequency Diffusion Sheet: First Embodiment>

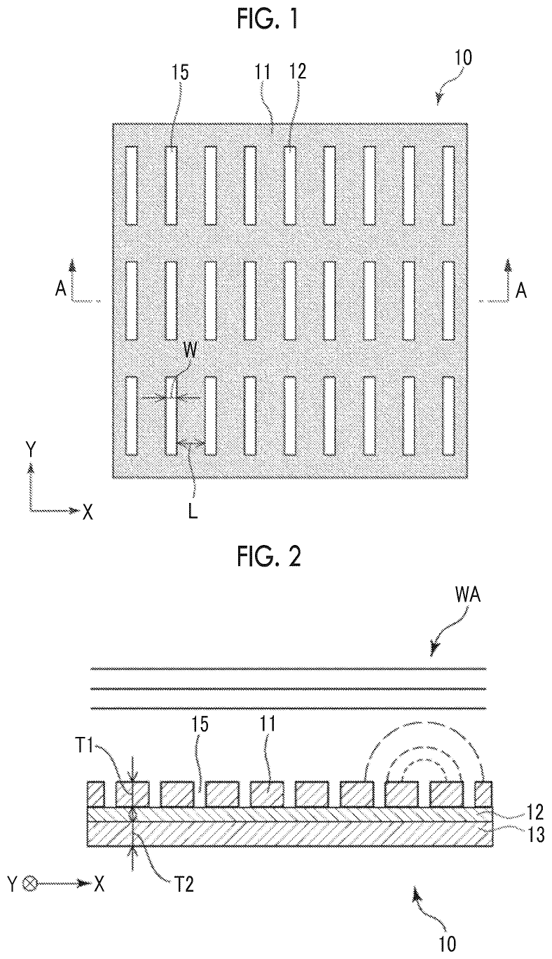

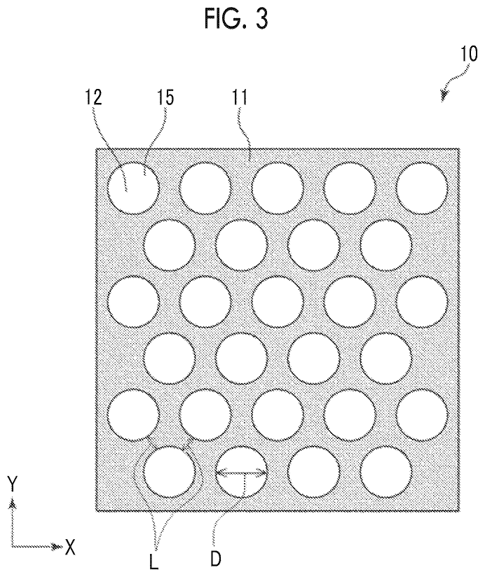

FIG. 1 is a plan view showing a first embodiment of a high-frequency diffusion sheet of the present invention, FIG. 2 is a cross-sectional view taken along the line A-A shown in FIG. 1, and FIG. 3 is a plan view showing another configuration of opening portions in an electromagnetic wave shielding layer of the high-frequency diffusion sheet in FIG. 1. In the following description, in FIGS. 1 and 3, the front side of the paper surface will be referred to as “upper”, and the back side of the paper surface will be referred to as “lower”, and in FIG. 2, the upper side will be referred to as “upper”, and the lower side will be referred to as “lower”. In addition, the vertical direction in FIGS. 1 and 3 and a front-back direction of the paper surface in FIG. 2 will be referred to as a Y direction, and the horizontal direction will be referred to as an X direction. Further, in each drawing referred to in the present specification, each of the dimensions in the horizontal direction and/or the thickness direction is exaggerated and is greatly different from the actual dimensions.

A high-frequency diffusion sheet 10 of the present invention is used for diffusing electromagnetic waves in a high frequency range, and is configured with a laminate including an electromagnetic wave shielding layer 11 that has electromagnetic wave shielding properties, and an electromagnetic wave reflection layer 13 that is laminated on the electromagnetic wave shielding layer 11 and has electromagnetic wave reflectivity. The electromagnetic wave shielding layer 11 is patterned in a plan view of the high-frequency diffusion sheet 10 (laminate), and has an opening portion 15 penetrating the electromagnetic wave shielding layer 11 in a thickness direction.

The high-frequency diffusion sheet 10 has the above configuration, that is, the high-frequency diffusion sheet 10 includes the electromagnetic wave shielding layer 11 that has electromagnetic wave shielding properties, and the electromagnetic wave reflection layer 13 that is laminated on the electromagnetic wave shielding layer 11 and has electromagnetic wave reflectivity, and further has the opening portion 15 penetrating the electromagnetic wave shielding layer 11 in the thickness direction. As a result, when the electromagnetic waves in the high frequency range are reflected on the electromagnetic wave reflection layer 13, the high-frequency diffusion sheet 10 can reliably diffract and diffuse the electromagnetic waves in the opening portion 15. Therefore, in a case where electromagnetic waves are received by a communication device inside a building (building structure), the high-frequency diffusion sheet 10 is attached to the wall portion or the like of the building before the electromagnetic waves in the high frequency range are transmitted through a transmission region through which the electromagnetic waves are allowed to be transmitted, such as a window portion of a building. As a result, the electromagnetic wave can be reflected on the electromagnetic wave reflection layer 13 without being absorbed by colliding with the wall portion or the like, and can be diffused, that is, diffracted in the opening portion 15 of the electromagnetic wave shielding layer 11. As a result, it is possible to obtain an opportunity for the electromagnetic wave to pass through the passage region again.

Further, after the electromagnetic waves in the high frequency range are transmitted through the transmission region and are introduced into the building, the high-frequency diffusion sheet 10 is attached to the wall portions, the curtains, or the like in the building. As a result, the electromagnetic waves can be reflected by the electromagnetic wave reflection layer 13 without being absorbed by colliding with the wall portions, the curtains, or the like, and can be diffused, that is, diffracted in the opening portion 15 of the electromagnetic wave shielding layer 11.

This enables a communication device to favorably receive the electromagnetic waves in a wide range inside a building.

The high-frequency diffusion sheet 10 may be attached to the roof portion, the door portion, or the like of the building in addition to the case of being attached to the wall portion of the building before the electromagnetic waves are transmitted through the transmission region as described above. In addition, after the electromagnetic waves are transmitted through the transmission region, in addition to the case in which the high-frequency diffusion sheet is attached to the wall portions or the curtains inside the building, even in a case in which the high-frequency diffusion sheet 10 is attached to door portions, blinds, desks, shelves, electrical appliances, or the like in the building, the electromagnetic waves can be diffused by the high-frequency diffusion sheet 10 when the electromagnetic waves are reflected by the window portions.

Hereinafter, the high-frequency diffusion sheet 10 including the electromagnetic wave shielding layer 11 having the opening portion 15 and the electromagnetic wave reflection layer 13 will be described.

In the present embodiment, as shown in FIGS. 1 and 2, the high-frequency diffusion sheet 10 has the electromagnetic wave shielding layer 11 having electromagnetic wave shielding properties, the electromagnetic wave reflection layer 13 having electromagnetic wave reflectivity, and a resin sheet 12 that supports the electromagnetic wave shielding layer 11 and the electromagnetic wave reflection layer 13, and the electromagnetic wave reflection layer 13, the resin sheet 12, and the electromagnetic wave shielding layer 11 are laminated in this order from the lower side.

### «Resin Sheet»

In the present embodiment, the resin sheet 12 (resin film) is provided by being bonded to the electromagnetic wave shielding layer 11 on the upper side thereof and is provided by being bonded to the electromagnetic wave reflection layer 13 on the lower side thereof. The resin sheet 12 is a resin sheet provided in the high-frequency diffusion sheet 10 in order to support the electromagnetic wave shielding layer 11 and the electromagnetic wave reflection layer 13 and to maintain the shape stability of the high-frequency diffusion sheet 10, and preferably has transparency.

Examples of the resin sheet 12 include thermosetting resins such as polyimide resin, polyamide resin, and epoxy resin; polyester resins such as polyethylene terephthalate and polyethylene naphthalate; olefin resins such as polypropylene and cycloolefin polymers; acrylic resins such as polymethyl methacrylate; and resins composed of thermoplastic resins such as polycarbonate resins as a main material. These resins are preferably used since the resins have transparency.

The average thickness of the resin sheet 12 is not particularly limited, but is preferably equal to or more than 0.01 mm and equal to or less than 100.0 mm, and more preferably equal to or more than 0.10 mm and equal to or less than 50.0 mm. By setting the average thickness of the resin sheet 12 within the range, the electromagnetic wave shielding layer 11 can be reliably supported by the resin sheet 12.

### «Electromagnetic Wave Reflection Layer»

The electromagnetic wave reflection layer 13 has a layered overall shape having no opening portion or the like, is laminated on the lower side of the resin sheet 12, and has a function of having an electromagnetic wave reflectivity that shields (blocks) electromagnetic waves in the entire region thereof by preferentially reflecting the electromagnetic waves.

The electromagnetic wave reflection layer 13 shields the electromagnetic waves incident on the electromagnetic wave reflection layer 13 by preferentially reflection. As a result, the electromagnetic waves incident into the high-frequency diffusion sheet 10 from the upper side of the high-frequency diffusion sheet 10 can be preferentially reflected on the upper side of the high-frequency diffusion sheet 10 while accurately suppressing or preventing the electromagnetic waves from being transmitted to the lower side of the high-frequency diffusion sheet 10.

Examples of the electromagnetic wave reflection layer 13 include a metal powder-containing adhesive layer, a thin metal film layer, a metal mesh, and a surface treatment of a conductive material such as ITO, and the same configuration as in a case where the electromagnetic wave shielding layer 11 described later is configured as a reflection layer can be adopted.

An average thickness T2 of the electromagnetic wave reflection layer 13 is not particularly limited, but is preferably equal to or more than 0.05 μm and equal to or less than 70.0 μm, and more preferably equal to or more than 1.0 μm and equal to or less than 40.0 μm. By setting the average thickness T2 of the electromagnetic wave reflection layer 13 within the above-described range, the electromagnetic waves incident into the high-frequency diffusion sheet 10 from the upper side of the high-frequency diffusion sheet 10 can be more preferentially reflected on the upper side of the high-frequency diffusion sheet 10 while more accurately suppressing or preventing the electromagnetic waves from being transmitted to the lower side of the high-frequency diffusion sheet 10.

### «Electromagnetic Wave Shielding Layer»

The electromagnetic wave shielding layer 11 has the opening portion 15 penetrating the electromagnetic wave shielding layer 11 in the thickness direction thereof, has a layered overall shape, and is laminated on the upper side of the resin sheet 12. In addition, the electromagnetic wave shielding layer 11 has electromagnetic wave shielding properties of suppressing or shielding transmission of electromagnetic waves in a region where the opening portion 15 is not formed, and has a function of allowing transmission of electromagnetic waves in a region where the opening portion 15 is formed.

This electromagnetic wave shielding layer 11 is not particularly limited and may be one in any form that shields electromagnetic waves in the region where the opening portions 15 are not formed. Examples thereof include a reflection layer that shields (blocks) electromagnetic waves incident on the electromagnetic wave shielding layer 11 by preferentially reflection, and an absorption layer that shields (blocks) electromagnetic waves incident on the electromagnetic wave shielding layer 11 by preferentially absorption. Among these, the electromagnetic wave shielding layer 11 is preferably a reflection layer. As a result, the electromagnetic waves incident on the electromagnetic wave shielding layer 11 can be shielded by preferentially reflection of the electromagnetic waves, and thus the transmittance of the electromagnetic waves that are transmitted through the opening portions 15 until reaching the electromagnetic wave reflection layer 13 can be improved.

As described above, the electromagnetic wave shielding layer 11 may shield the electromagnetic waves by any of reflection or absorption of the incident electromagnetic waves. However, in the present specification, a layer that shields electromagnetic waves by preferentially reflection between reflection and absorption is referred to as a reflection layer, and a layer that shields electromagnetic waves by preferentially absorption between reflection and absorption is referred to as an absorption layer.

Hereinbelow, each of the reflection layer and the absorption layer will be described.

The reflection layer shields the electromagnetic waves incident on the reflection layer by preferentially reflection.

Examples of the reflection layer include a metal powder-containing adhesive layer, a thin metal film layer, a metal mesh, and a surface treatment of a conductive material such as ITO. These may be used alone or in combination. Among these, the metal powder-containing adhesive layer and the thin metal film layer are preferably used. The metal powder-containing adhesive layer and the thin metal film layer exhibit excellent electromagnetic wave shielding properties even when the film thickness (thickness) is set to be relatively thin, and thus are preferably used as the reflection layer.

The metal powder-containing adhesive layer is configured to contain a metal powder and a binder resin, and examples of the metal powder include gold, silver, copper, silver-coated copper, and nickel. Among these, silver is preferably used because silver is excellent in electromagnetic wave shielding properties.

The content ratio of the metal powder and the binder resin in the metal powder-containing adhesive layer is not particularly limited, but is preferably 40:60 to 95:5, and is more preferably 50:50 to 90:10 in weight ratio.

The metal powder-containing adhesive layer may further contain a flame retardant, a leveling agent, a viscosity adjuster, or the like in addition to the metal powder and the binder resin.

Examples of the thin metal film layer include vapor-deposited films and metal foils which are composed of, as a main material, the metals exemplified for the metal powder contained in the metal powder-containing adhesive layer.

The absorption layer absorbs the electromagnetic waves incident on the absorption layer to shield the electromagnetic waves from being converted into thermal energy preferentially.

Examples of the absorption layer include a conductive absorption layer composed of, as a main material, a conductive absorption material such as a metal powder and a conductive polymer material; a dielectric absorption layer composed of, as a main material, a dielectric absorption material such as a carbon material and a conductive polymer material; and a magnetic absorption layer composed of, as a main material, a magnetic absorption material such as a soft magnetic metal. These may be used alone or in combination, and a layer configured to contain these main materials and a binder resin is preferably used.

The conductive absorption layer absorbs electromagnetic waves by converting electromagnetic energy into thermal energy by a current flowing inside the material when an electric field is applied. In addition, the dielectric absorption layer absorbs electromagnetic waves by converting the electromagnetic waves into thermal energy through dielectric loss. In addition, the magnetic absorption layer absorbs electromagnetic waves by consuming the energy of radio waves by converting the energy of radio waves into heat through magnetic loss such as overcurrent loss, hysteresis loss, and magnetic resonance.

Examples of the conductive absorption material include conductive polymers, metal oxides such as ATO, and conductive ceramics.

Further, examples of the conductive polymers include polyacetylene, polypyrrole, poly-ethylenedioxythiophene (PEDOT), PEDOT/PSS, polythiophene, polyaniline, poly(p-phenylene), polyfluorene, polycarbazole, polysilane, and derivatives thereof. One or two or more of these can be used in combination.

Examples of the dielectric absorption material include carbon materials, conductive polymers, and ceramic materials.

Further, examples of the carbon materials include carbon nanotubes such as single-walled carbon nanotubes and multi-walled carbon nanotubes, carbon nanofibers, CN nanotubes, CN nanofibers, BCN nanotubes, BCN nanofibers, graphene, and carbon such as carbon microcoils, carbon nanocoils, carbon nanohorns, and carbon nanowalls. One or two or more of these can be used in combination.

Examples of the ceramic materials include barium titanate, perovskite-type barium zirconate titanate calcium crystal particles, titania, alumina, zirconia, silicon carbide, and aluminum nitride. One or two or more of these can be used in combination.

Further, examples of the magnetic absorption material include iron, silicon steel, magnetic stainless steel (Fe—Cr—Al—Si alloy), Sendust (Fe—Si—Al alloy), permalloy (Fe—Ni alloy), silicon copper (Fe—Cu—Si alloy), Fe—Si alloy, soft magnetic metals such as Fe—Si—B(—Cu—Nb) alloys, and ferrites.

In addition, when the absorption layer and the absorption layer contain a binder resin, this binder resin is not particularly limited, and various resin materials can be used. Examples thereof include thermosetting resins such as epoxy resins, phenolic resins, amino resins, unsaturated polyester resins, and thermosetting elastomers; and thermoplastic resins such as olefin resins, polyamide resins, polyimide resins, acrylic resins, polyester resins, vinyl chloride resins, styrene resins, and thermoplastic elastomers such as styrene thermoplastic elastomers and olefin thermoplastic elastomers. One or two or more of these can be used in combination.

The average thickness of the reflection layer and the absorption layer, that is, the average thickness T1 of the electromagnetic wave shielding layer 11 is not particularly limited, but is preferably equal to or more than 0.05 μm and equal to or less than 70.0 μm, and more preferably equal to or more than 1.0 μm and equal to or less than 40.0 μm. By setting the average thickness T1 of the electromagnetic wave shielding layer 11 within the range, it is possible to reliably suppress or shield the transmission of electromagnetic waves in the region where the opening portion 15 is not formed. Therefore, in the opening portions 15, the electromagnetic waves transmitted through the opening portions 15 can be reliably diffracted.

As shown in FIGS. 1 and 2, the opening portions 15 are through-holes penetrating the electromagnetic wave shielding layer 11 in the thickness direction.

By providing such opening portions 15, for example, when electromagnetic waves (plane waves WA) in a high frequency range (frequency: about equal to or more than 1 GHz and equal to or less than 80 GHZ) are incident on the electromagnetic wave shielding layer 11 from the upper side of the high-frequency diffusion sheet 10, the electromagnetic waves are reflected by the electromagnetic wave reflection layer 13 through the opening portions 15. When the reflected electromagnetic waves are transmitted toward the upper side of the electromagnetic wave shielding layer 11, the electromagnetic waves are diffracted in the opening portion 15 and are diffused to the upper side of the high-frequency diffusion sheet 10. Therefore, in a case where electromagnetic waves are received by a communication device inside a building (building structure), the high-frequency diffusion sheet 10 is attached to a wall portion or the like of the building before the electromagnetic waves in the high frequency range are transmitted through a transmission region through which the electromagnetic waves are allowed to be transmitted, such as a window portion of a building. Accordingly, since the electromagnetic waves can be diffused by the high-frequency diffusion sheet 10 without being absorbed by colliding with the wall portion or the like, it is possible to obtain an opportunity for the electromagnetic waves to pass through the passage region again. Further, after the electromagnetic waves in the high frequency range are transmitted through the transmission region and are introduced into the building, the high-frequency diffusion sheet 10 is attached to the wall portions, the curtains, or the like in the building. As a result, the high-frequency diffusion sheet 10 can diffuse the electromagnetic waves (refer to FIG. 2). Therefore, the electromagnetic waves in the high frequency range can be favorably received by a communication device in a wide range inside the building.

It is preferable that a width W (average width) of the opening portion 15 is set to be equal to or less than the wavelength of the electromagnetic waves transmitted through the opening portion 15. That is, regarding the width W of the opening portion 15, it is preferable that when W [mm] is an average width of the opening portion and λ [mm] is a wavelength of the electromagnetic waves, W/λ is equal to or less than 1.0. As a result, when the electromagnetic waves are transmitted through the electromagnetic wave shielding layer 11, the electromagnetic waves can be diffused by being more reliably diffracted by the opening portion 15.

As shown in FIG. 1, in the present embodiment, the number of the opening portions 15 having such a configuration is not limited in the electromagnetic wave shielding layer 11. In the present embodiment, nine rows are disposed at equal intervals along an X direction (lateral direction of the opening portions 15), three rows are disposed at equal intervals along a Y direction (longitudinal direction of the opening portions 15), and a total of 27 portions (plurality) are formed.

The separated distances L between the opening portions 15 adjacent in the X direction are the same as each other. Further, in the present embodiment, each of the opening portions 15 has a long shape, that is, a rectangular shape that extends linearly along the Y direction (longitudinal direction of the opening portions 15). The lengths are the same as each other, and the widths W are also the same as each other.

By disposing and shaping each of the opening portions 15 as described above, the electromagnetic waves in the high frequency range can be uniformly diffracted by the opening portions 15 in the electromagnetic wave shielding layer 11.

The shape of each of the opening portions 15 is a rectangular shape, that is, a linear shape when seen in a plan view, but is not limited thereto as long as the width W is set to be smaller than the wavelength of the electromagnetic waves. Examples of other shapes of the opening portions 15 include shapes having a curved portion such as a S shape, a U shape, a semi-circular shape, and a wave shape; and shapes having a corner portion such as a V shape, an X shape, an L shape, an H shape, a T shape, a W shape, and an open-box shape, in addition to the case of forming a circular shape as shown in FIG. 3. Further, in a case where the shape of the opening portion 15 is a circular shape as shown in FIG. 3 when seen in a plan view, the diameter D of the circle corresponds to the width W in a case where the shape of the opening portion 15 is a rectangular shape. Further, the shortest distance between adjacent circles is handled in the same manner as the separated distance L between the opening portions 15 adjacent in the X direction when the shape of the opening portions 15 is a rectangular shape.

In addition, in the present embodiment, a case where the opening portions 15 have the same shape and are formed at equal intervals in the electromagnetic wave shielding layer 11 has been described, but the present invention is not limited thereto. Each of the opening portions 15 may have different shapes from each other, or may be randomly disposed in the electromagnetic wave shielding layer 11. Further, the opening portions 15 is not limited to the case in which the electromagnetic wave shielding layer 11 has a plurality of opening portions, and the electromagnetic wave shielding layer 11 may have at least one opening portion.

### «Pressure-Sensitive Adhesive Layer»

In addition, the high-frequency diffusion sheet 10 may include a pressure-sensitive adhesive layer that is laminated on a surface of the electromagnetic wave reflection layer 13 opposite to the resin sheet 12. Accordingly, the high-frequency diffusion sheet 10 can be easily attached to a region of a building (building structure) to which the high-frequency diffusion sheet 10 is to be attached.

This pressure-sensitive adhesive layer is not particularly limited, but is preferably mainly composed of at least one pressure-sensitive adhesive among an acrylic pressure-sensitive adhesive, a silicone pressure-sensitive adhesive, a rubber pressure-sensitive adhesive, and the like.

Examples of the acrylic pressure-sensitive adhesive include resins composed of (meth)acrylic acid and esters thereof, and copolymers of (meth)acrylic acid and esters thereof and unsaturated monomers (such as vinyl acetate, styrene, and acrylonitrile) copolymerizable therewith. In addition, two or more these resins may be mixed.

Examples of the rubber pressure-sensitive adhesive include natural rubber-based, isoprene rubber-based, styrene-butadiene-based, recycled rubber-based, polyisobutylene-based pressure-sensitive adhesives, and pressure-sensitive adhesives mainly composed of block copolymers containing rubber such as styrene-isoprene-styrene and styrene-butadiene-styrene.

Further, examples of silicone pressure-sensitive adhesives include dimethylsiloxane-based and diphenylsiloxane-based pressure-sensitive adhesives.

In addition, various additives such as plasticizers, tackifiers, thickeners, fillers, anti-aging agents, preservatives, mildew-proofing agents, dyes, and pigments may be added to the pressure-sensitive adhesive layer as necessary.

In the present embodiment, the case where the high-frequency diffusion sheet 10 includes one resin sheet 12 between the electromagnetic wave shielding layer 11 and the electromagnetic wave reflection layer 13 has been described, but the present invention is not limited thereto. The resin sheet 12 may be provided on at least one of a side of the electromagnetic wave shielding layer 11 opposite to the electromagnetic wave reflection layer 13 and a side of the electromagnetic wave reflection layer 13 opposite to the electromagnetic wave shielding layer 11, or alternatively, the resin sheet 12 may not be formed.

In addition, the high-frequency diffusion sheet 10 may further include an interlayer or the like in at least one of a space between the electromagnetic wave shielding layer 11 and the resin sheet 12 and a space between the resin sheet 12 and the pressure-sensitive adhesive layer.

### Second Embodiment

Next, the second embodiment of the high-frequency diffusion sheet of the present invention will be described.

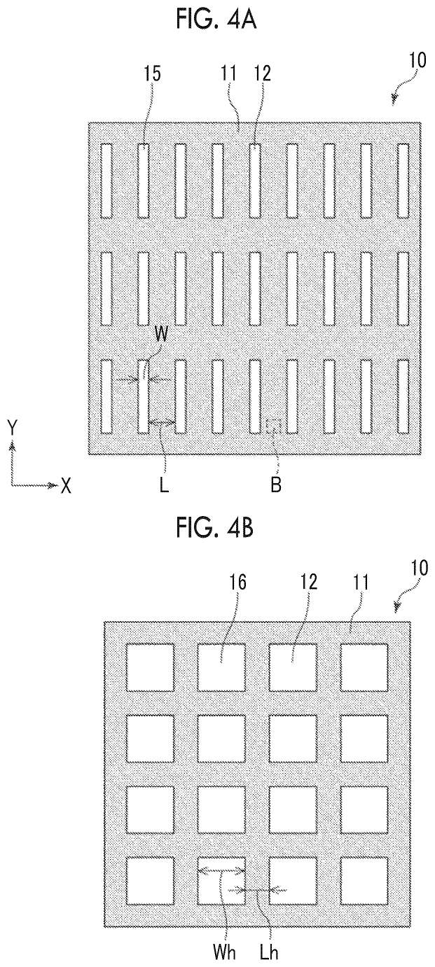

FIGS. 4A and 4B are plan views showing the second embodiment of the high-frequency diffusion sheet of the present invention. FIG. 4A is an overall view of the high-frequency diffusion sheet of the second embodiment. FIG. 4B is a partially enlarged plan view of the high-frequency diffusion sheet located in a region [B] enclosed by the dotted line in FIG. 4A. In addition, in the following description, the front side of the paper surface in FIGS. 4A and 4B is referred to as “up”, and the back side of the paper surface is referred to as “down”. In addition, in FIGS. 4A and 4B, the vertical direction will be referred to as a Y direction, and the horizontal direction will be referred to as an X direction.

Hereinafter, the high-frequency diffusion sheet 10 of the second embodiment will be described with a focus on the differences from the high-frequency diffusion sheet 10 of the first embodiment, and the description of the same features will not be repeated.

The high-frequency diffusion sheet 10 shown in FIGS. 4A and 4B is the same as the high-frequency diffusion sheet 10 of the first embodiment shown in FIG. 1 except that the configurations of the electromagnetic wave shielding layer 11 and the electromagnetic wave reflection layer 13 provided in the high-frequency diffusion sheet 10 are different.

In other words, in the high-frequency diffusion sheet 10 of the second embodiment, in the region where the opening portions 15 are not formed, that is, in the region that suppresses or shields the transmission of electromagnetic waves, the electromagnetic wave shielding layer 11 has a plurality of through-holes 16 penetrating the electromagnetic wave shielding layer 11 in the thickness direction, the through-holes being formed to have a size smaller than a size of the opening portion 15. In addition, the electromagnetic wave reflection layer 13 has a plurality of through-holes having the same configuration as the through-hole 16 of the electromagnetic wave shielding layer 11 in the entire region thereof, that is, in a region where electromagnetic waves are reflected.

Here, as described above, the high-frequency diffusion sheet 10 of the present invention is used by being attached to wall portions of a building (building structure) or curtains or the like disposed inside a building, but there may be a demand for the attachment not being visible. That is, the high-frequency diffusion sheet 10 may be required to have transparency.

In addition, in the high-frequency diffusion sheet 10, in the region where the opening portions 15 are not formed, the electromagnetic wave shielding layer 11 contains a material that exhibits electromagnetic wave blocking properties as a main material to suppress or shield the transmission of electromagnetic waves. However, this material exhibiting electromagnetic wave blocking properties may exhibit translucency or opaqueness. In addition, in order to reflect the electromagnetic waves, the electromagnetic wave reflection layer 13 contains a material exhibiting electromagnetic wave reflectivity in the entire region as a main material, but the material exhibiting electromagnetic wave reflectivity may exhibit translucency or opaqueness, similarly to the material exhibiting electromagnetic wave blocking properties.

Therefore, even when the electromagnetic wave shielding layer 11 and the electromagnetic wave reflection layer 13 contain the material exhibiting translucency or opaqueness, in the present embodiment, in the region where the opening portions 15 are not formed, in the present embodiment, the electromagnetic wave shielding layer 11 has a plurality of the through-holes 16 penetrating the electromagnetic wave shielding layer 11 in the thickness direction thereof and formed to have a size smaller than a size of the opening portions 15, in order to impart transparency to the high-frequency diffusion sheet 10. In addition, the electromagnetic wave reflection layer 13 has a plurality of through-holes having the same configuration as the through-holes 16 in the entire region thereof. This allows the transmission of visible light through the through-holes 16 of the electromagnetic wave shielding layer 11 and the through-holes of the electromagnetic wave reflection layer 13 even when the electromagnetic wave shielding layer 11 and the electromagnetic wave reflection layer 13 contain the material exhibiting translucency or opaqueness, which makes it possible to reliably impart transparency to the electromagnetic wave shielding layer 11 and the electromagnetic wave reflection layer 13, that is, the high-frequency diffusion sheet 10.

In addition, since the through-holes 16 of the electromagnetic wave shielding layer 11 and the through-holes of the electromagnetic wave reflection layer 13 have the same configuration, the through-holes 16 will be described as a representative.

The through-hole 16 may have any shape and size as long as the through-hole 16 is formed to have a size smaller than a size of the opening portion 15 so as to allow transmission of visible light while suppressing transmission of electromagnetic waves. However, as shown in FIG. 4B, in a case where the through-hole 16 has a square shape, specifically, a width Wh of the through-hole 16 may be about equal to or more than 1 μm and less than 1000 μm, preferably about equal to or more than 50 μm and less than 1000 μm, and more preferably about equal to or more than 100 μm and equal to or less than 250 μm in a case where the frequency of the radio wave to be used is 28 GHZ. In addition, in this case, a separated distance Lh between the through-holes 16 may be, for example, about equal to or more than 1 μm and equal to or less than 150 μm, and is preferably about equal to or more than 10 μm and equal to or less than 150 μm and more preferably about equal to or more than 30 μm and equal to or less than 75 μm. By setting each of the width Wh and the separated distance Lh of the square-shaped through-holes 16 within the above-mentioned ranges, the through-holes 16 can allow the transmission of visible light while reliably suppressing the transmission of electromagnetic waves.

The through-holes 16 may have any shape and size as long as the through-holes are formed to have a size smaller than a size of the opening portions 15 to allow the transmission of visible light while suppressing the transmission of electromagnetic waves. However, the opening ratio of the through-holes 16 in the electromagnetic wave shielding layer 11 is preferably 80% to 95% and more preferably 83% to 94%. In addition, when λ [mm] is the wavelength of the electromagnetic waves, the width of the through-hole 16 is preferably equal to or less than λ/10 [mm], and more specifically, in a case where the frequency of the radio wave used is 28 GHZ, the width of the through-hole 16 is preferably equal to or less than 1000 μm and more preferably equal to or less than 800 μm. By setting the diameter of the through-hole 16 to be within the range, the through-hole 16 which can allow transmission of visible light while reliably suppressing transmission of electromagnetic waves can be obtained.

As shown in FIG. 4B, in the present embodiment, the shape of each of the through-holes 16 forms a square shape when seen in a plan view, but the shape is not limited to this shape. Examples of other shapes of the through-holes 16 include shapes having a corner portion such as a S shape, a U shape, a circular shape, a semi-circular shape, and a wave shape; and shapes having a corner portion such as a linear shape, a V shape, an X shape, an L shape, an H shape, a T shape, a W shape, and an open-box shape.

In addition, in the present embodiment, the case in which the through-holes 16 having the same shape are formed in the electromagnetic wave shielding layer 11 at equal intervals has been described. However, there is no limitation, and each of the through-holes 16 may have shapes different from each other or may be randomly disposed on the electromagnetic wave shielding layer 11.

Even with the high-frequency diffusion sheet 10 according to the second embodiment, the same effects as those of the first embodiment can be obtained.

The dimensions of each part are the same as those of the high-frequency diffusion sheet 10 of the first embodiment.

In the high-frequency diffusion sheet 10 of the second embodiment, which is configured as described above, the light transmittance of visible light at a wavelength of equal to or more than 300 nm and equal to or less than 800 nm is preferably equal to or more than 70% and equal to or less than 100%, and more preferably equal to or more than 90% and equal to or less than 100%. As a result, it can be said that the high-frequency diffusion sheet 10 has excellent light transmittance, and the visibility of the high-frequency diffusion sheet 10 attached to a member such as a wall portion or a curtain can be reduced. The light transmittance can be measured by an ultraviolet-visible spectrophotometer, for example.

### Third Embodiment

In addition, the high-frequency diffusion sheet 10 may have the following configuration in addition to the configuration described in the first embodiment.

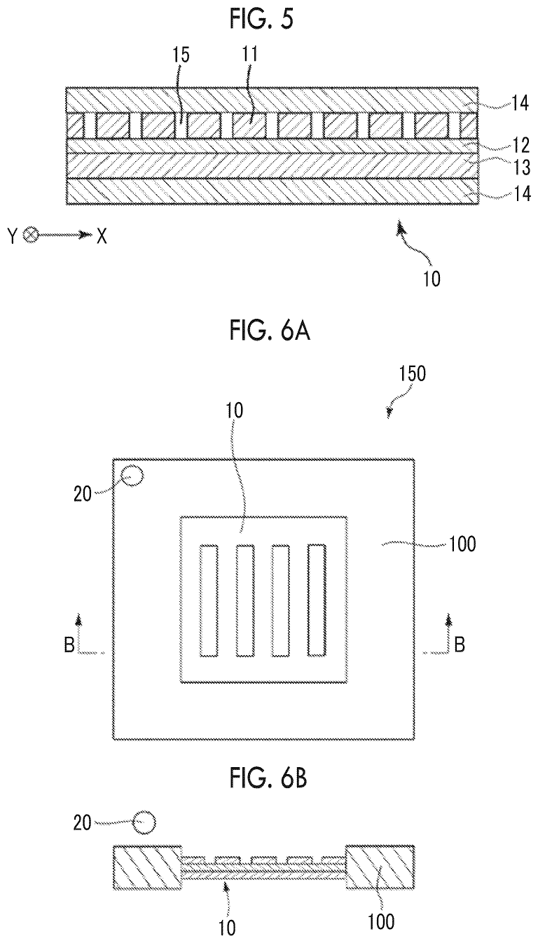

FIG. 5 is a longitudinal sectional view showing the third embodiment of the high-frequency diffusion sheet of the present invention.

Hereinafter, for convenience of description, the upper side of FIG. 5 will be referred to as “upper” and the lower side thereof will be referred to as “lower”. In addition, the front-back direction of the paper surface in FIG. 5 is referred to as a Y direction, and the horizontal direction is referred to as an X direction.

Hereinafter, the high-frequency diffusion sheet 10 of the third embodiment will be described with a focus on the differences from the high-frequency diffusion sheet 10 of the first embodiment, and the description of the same features will not be repeated.

The high-frequency diffusion sheet 10 shown in FIG. 5 is the same as the high-frequency diffusion sheet 10 of the first embodiment except that a protective layer 14 is further formed as an outermost layer on a side of the electromagnetic wave shielding layer 11 and on a side of the electromagnetic wave reflection layer 13 opposite to the resin sheet 12.

That is, as shown in FIG. 5, in the present embodiment, in the high-frequency diffusion sheet 10, the protective layer 14 on the electromagnetic wave reflection layer 13 side is provided on the lower side, and the protective layer 14, the electromagnetic wave reflection layer 13, the resin sheet 12, the electromagnetic wave shielding layer 11, and the protective layer 14 are in contact with each other and are laminated in this order toward the upper side.

In the high-frequency diffusion sheet 10 having such a configuration, electromagnetic waves are incident from the upper side, that is, the resin sheet 12 side, and thus the incident electromagnetic waves can be diffused while being reflected on the upper side.

In addition, in the high-frequency diffusion sheet 10, since the protective layer 14 is located as the outermost layer and protects the electromagnetic wave reflection layer 13 and the electromagnetic wave shielding layer 11, it is possible to reliably prevent the electromagnetic wave reflection layer 13 and the electromagnetic wave shielding layer 11 from being damaged during use.

The protective layer 14 is not particularly limited, but can be formed of, for example, a layer in which the metal powder is not added in the above-described metal powder-containing adhesive layer.

In addition, the average thickness of the protective layer 14 is preferably equal to or more than 0.05 μm and equal to or less than 70.0 μm, and more preferably equal to or more than 1.0 μm and equal to or less than 40.0 μm. By setting the thickness of the protective layer 14 within such a range, the function as the protective layer 14 can be reliably imparted.

The same effects as those of the first embodiment is also obtained with such a high-frequency diffusion sheet 10 of the third embodiment.

Hereinbefore, the high-frequency diffusion sheet of the present invention has been described, but the present invention is not limited thereto.

For example, in the high-frequency diffusion sheet of the present invention, each configuration can be replaced with any member that can exhibit similar functions, or alternatively, a member having any configuration can be added.

In addition, in the high-frequency diffusion sheet of the present invention, any two or more configurations (features) shown in the first to third embodiments may be combined.

### EXAMPLES

Hereinbelow, the present invention will be described more specifically based on examples. The present invention is not limited to these examples.

### 1. Examination of Diffuseness of Electromagnetic Waves by High-Frequency Diffusion Sheet

### 1-1. Preparation of Film and the Like

### <Metal-Foil-Laminated Resin Film>

An aluminum foil with an average thickness of 12 μm was bonded to each of both surfaces of a PET substrate (resin sheet 12) with an average thickness of 0.1 mm with an acrylic adhesive to prepare an aluminum foil-PET substrate-aluminum foil laminate as a metal-foil-laminated resin film.

### <Frame>

As the frame 100 that does not allow the transmission of electromagnetic waves, a frame formed from an aluminum plate and having a square outer shape and square opening portions was prepared (outer shape: 200 mm×200 mm, opening portion: 100 mm×100 mm).

### 1-2. Production of High-Frequency Diffusion Sheet

### (Sample No. 1A)

The prepared metal-foil-laminated resin film (aluminum foil-PET substrate-aluminum foil laminate) was cut into a size of 100 mm×100 mm. Thereafter, by subjecting one of the two aluminum foils provided in the metal-foil-laminated resin film to a metal etching treatment, a total of 10 aluminum foils were provided with opening portions 15 (slits) having a length of 90 mm and a width of W5 mm such that a separated distance L (interval) was 5 mm. As a result, a high-frequency diffusion sheet 10 of sample No. 1A in which the electromagnetic wave reflection layer 13, the resin sheet 12, and the electromagnetic wave shielding layer 11 were laminated in this order was produced.

### (Sample Nos. 2A to 10A)

High-frequency diffusion sheets 10 of sample Nos. 2A to 10A were produced in the same manner as in the above-mentioned sample No. 1A except that at least one of the length and the width W of the opening portions 15 formed on one aluminum foil, the separated distance L between the opening portions 15, and the number of the opening portions 15 was changed as shown in Table 1.

### (Sample No. 11A)

As a high-frequency diffusion sheet 10 of sample No. 11A, a sheet in which the opening portions 15 were not formed on the aluminum foil was prepared.

### 1-3. Evaluation

### <Confirmation of Diffuseness of Electromagnetic Waves>

<1A> First, the high-frequency diffusion sheets 10 of each of the sample numbers were mounted on the frame 100 so as to correspond to the opening portions provided in the frame 100, thereby obtaining a test sample 150 for confirming diffraction of electromagnetic waves (refer to FIGS. 6A and 6B).
<2A> Subsequently, as shown in FIGS. 6A and 6B, a receiver 20 was disposed such that the receiver was 10 mm inward in the plane direction from the end portion of the frame 100, and the separated distance in the thickness direction from the frame 100 was 10 mm.
<3A> Next, electromagnetic waves (plane waves) having a frequency of 28 GHz were incident on the high-frequency diffusion sheets 10 of each of the sample numbers from the surface of the test sample 150 on which the receiver 20 was disposed while preventing the electromagnetic waves from being incident on the receiver 20, and then the electromagnetic waves reflected by the high-frequency diffusion sheet 10 were received using the receiver 20. Then, the presence or absence of diffraction (diffusion) of the electromagnetic waves by the high-frequency diffusion sheet 10 was evaluated based on the following evaluation criteria.

### Evaluation Criteria

A: the electromagnetic waves could be clearly received by the receiver 20.
B: the electromagnetic waves could be sufficiently received by the receiver 20 although the reception could not be said to be clear.
C: the electromagnetic waves could be received by the receiver 20 although the reception intensity could not be said to be sufficient.
5 D: the reception intensity was an intensity that could not be said that the electromagnetic waves could be received by the receiver 20.

Table 1 below shows each of the evaluation results obtained as described above.

TABLE 1

| | | | | | | | | | | | | Comparative |
|---|---|---|---|---|---|---|---|---|---|---|---|---|
| Examination of electromagnetic | | Example | | | | | | | | | | Example |
| waves with frequency of 28 GHz | | Sample No. | | | | | | | | | | |
| (wavelength of 10.7 mm) | | 1A | 2A | 3A | 4A | 5A | 6A | 7A | 8A | 9A | 10A | 11A |
| Opening | Shape | Rectangular shape | | | | | | | | | | Not formed |
| portion 15 | Length [mm] | 90 | | | | | | | | | | — |
| | Width W [mm] | 5 | | | 7.5 | | | 10 | | | 20 | — |
| | Separated distance L [mm] | 5 | 7.5 | 10 | 5 | 7.5 | 10 | 5 | 7.5 | 10 | 5 | |
| | Number of opening | 10 | 8 | 7 | 8 | 7 | 5 | 7 | 5 | 5 | 4 | — |
| | portions | | | | | | | | | | | |
| Evaluation | Presence or absence | B | C | C | A | B | B | B | C | C | C | D |
| | of diffraction of | | | | | | | | | | | |
| | electromagnetic waves | | | | | | | | | | | |

As shown in Table 1, the results show that since the high-frequency diffusion sheet 10 had the electromagnetic wave shielding layer 11 and the electromagnetic wave reflection layer 13, and the electromagnetic wave shielding layer 11 had the opening portions 15 penetrating the electromagnetic wave shielding layer 11 in the thickness direction, the electromagnetic waves were diffused by being diffracted by the opening portions 15 of the electromagnetic wave shielding layer 11 when the electromagnetic waves were reflected by the high-frequency diffusion sheet 10. Further, it became clear that the electromagnetic waves could be diffused with better diffuseness by setting the width W of the opening portions 15 to be smaller than the wavelength of the electromagnetic waves and by appropriately setting the separated distance L between the opening portions 15.

### 2. Examination of Transmittance of Visible Light in High-Frequency Diffusion Sheet

### 2-1. Preparation of Film and the Like

### <Metal-Foil-Laminated Resin Film>

An aluminum foil with an average thickness of 12 μm was bonded to each of both surfaces of a PET substrate (resin sheet 12) with an average thickness of 0.1 mm with an acrylic adhesive to prepare an aluminum foil-PET substrate-aluminum foil laminate as a metal-foil-laminated resin film.

### <Frame>

As the frame 100 that does not allow the transmission of electromagnetic waves, a frame formed from an aluminum plate and having a square outer shape and square opening portions was prepared (outer shape: 200 mm×200 mm, opening portion: 100 mm×100 mm).

### 2-2. Production of High-Frequency Diffusion Sheet

### (Sample No. 1B)

The prepared metal-foil-laminated resin film (aluminum foil-PET substrate-aluminum foil laminate) was cut into a size of 100 mm×100 mm. Thereafter, one of the two aluminum foils included in the metal-foil-laminated resin film was irradiated with a laser to provide a total of 10 aluminum foils with opening portions 15 (slits) having a length of 90 mm and a width of W of 5 mm at a separated distance L (interval) of 5 mm. Thereafter, through-holes 16 having a square shape with a width Wh of 250 μm were formed in a lattice shape by laser irradiation at a separated distance Lh of 50 μm in a region of one aluminum foil where the opening portions 15 were not formed and the entire region of the other aluminum foil. As a result, a high-frequency diffusion sheet 10 of sample No. 1B in which the electromagnetic wave reflection layer 13, the resin sheet 12, and the electromagnetic wave shielding layer 11 were laminated in this order was produced.

### (Sample Nos. 2B to 9B)

High-frequency diffusion sheets 10 of sample Nos. 2B to 9B were produced in the same manner as in the above-mentioned sample No. 1B except that at least one of the width W of the opening portions 15 formed on the aluminum foil and the separated distance L between the opening portions 15 was changed as shown in Table 2.

### 2-3. Evaluation

### <Confirmation of Diffuseness of Electromagnetic Waves>

<1A> First, the high-frequency diffusion sheets 10 of each of the sample numbers were mounted on the frame 100 so as to correspond to the opening portions provided in the frame 100, thereby obtaining a test sample 150 for confirming diffraction of electromagnetic waves (refer to FIGS. 6A and 6B).
<2A> Subsequently, as shown in FIGS. 6A and 6B, a receiver 20 was disposed such that the receiver was 10 mm inward in the plane direction from the end portion of the frame 100, and the separated distance in the thickness direction from the frame 100 was 10 mm.
<3A> Next, electromagnetic waves (plane waves) having a frequency of 28 GHz were incident on the high-frequency diffusion sheets 10 of each of the sample numbers from the surface of the test sample 150 on which the receiver 20 was disposed while preventing the electromagnetic waves from being incident on the receiver 20, and then the electromagnetic waves reflected by the high-frequency diffusion sheet 10 were received using the receiver 20. Then, the presence or absence of diffraction (diffusion) of the electromagnetic waves by the high-frequency diffusion sheet 10 was evaluated based on the following evaluation criteria.

### Evaluation Criteria

A: the electromagnetic waves could be clearly received by the receiver 20.
B: the electromagnetic waves could be sufficiently received by the receiver 20 although the reception could not be said to be clear.
C: the electromagnetic waves could be received by the receiver 20 although the reception intensity could not be said to be sufficient.
D: the reception intensity was an intensity that could not be said that the electromagnetic waves could be received by the receiver 20.

### <Confirmation of Transmittance of Visible Light>

For the high-frequency diffusion sheets 10 of each of the sample numbers, the light transmittance (%) of visible light at a wavelength of equal to or more than 300 nm and equal to or less than 800 nm was measured using an ultraviolet-visible spectrophotometer (“UV-2600i”, manufactured by Shimadzu Corporation). Then, the presence or absence of transmission of visible light by the high-frequency diffusion sheet 10 was evaluated based on the following evaluation criteria.

### Evaluation Criteria

The light transmittance of visible light at a wavelength of equal to or more than 300 nm and equal to or less than 800 nm was as follows.
A: equal to or more than 70%.
B: equal to or more than 50% and less than 70%.
C: less than 50%.

Table 2 below shows each of the evaluation results obtained as described above.

TABLE 2

| Examination of electromagnetic | | Example | | | | | | | | |
|---|---|---|---|---|---|---|---|---|---|---|
| waves with frequency of 28 GHz | | Sample No. | | | | | | | | |
| (wavelength of 10.7 mm) | | 1B | 2B | 3B | 4B | 5B | 6B | 7B | 8B | 9B |
| Opening | Shape | Rectangular shape | | | | | | | | |
| portion 15 | Length [mm] | 90 | | | | | | | | |
| | Width W [mm] | 5 | | | 7.5 | | | 10 | | |
| | Separated distance L [mm] | 5 | 7.5 | 10 | 5 | 7.5 | 10 | 5 | 7.5 | 10 |
| | Number of opening portions | 10 | 8 | 7 | 8 | 7 | 5 | 7 | 5 | 5 |
| Evaluation | Presence or absence of diffraction | B | C | C | A | B | B | B | C | C |
| | of electromagnetic waves | | | | | | | | | |
| | Presence or absence of | A | A | A | A | A | A | A | A | A |
| | transmission of visible light | | | | | | | | | |

As shown in Table 2, the results show that since the electromagnetic wave shielding layer 11 provided in the high-frequency diffusion sheet 10 had the opening portions 15 penetrating the electromagnetic wave shielding layer 11 in the thickness direction, the electromagnetic waves were diffused by being diffracted by the opening portions 15 of the electromagnetic wave shielding layer 11 when the electromagnetic waves were reflected by the high-frequency diffusion sheet 10. In the sample Nos. 1B to 9B, the diffractiveness of the electromagnetic waves by the opening portions 15 showed a similar tendency as that of the sample Nos. 1A to 10A in Table 1 in which the through-holes 16 were not formed in the region where the opening portions 15 of the electromagnetic wave shielding layer 11 were not formed. Therefore, it was found that electromagnetic waves could be diffracted (diffused) at the opening portions 15 even when the through-holes 16 were formed in the region where the opening portions 15 of the electromagnetic wave shielding layer 11 were not formed.

In addition, it became clear that, by forming the through-holes 16 in the region of the electromagnetic wave shielding layer 11 where the opening portions 15 were not formed and the entire region of the electromagnetic wave reflection layer 13, the transmittance of visible light could be imparted to the high-frequency diffusion sheet 10.

3. Examination of Diffuseness and Transmittance in Opening Portions with Different Lengths

### 3-1. Preparation of Frame

### <Frame>

As the frame 100 that does not allow the transmission of electromagnetic waves, a frame formed from an aluminum plate and having a square outer shape and square opening portions was prepared (outer shape: 600 mm×600 mm, opening portion: 300 mm×300 mm).

### 3-2. Production of High-Frequency Diffusion Sheet

### (Sample No. 1C)

A copper foil having an average thickness of 12 μm was laminated on each of both surfaces of the PET substrate (resin sheet 12) melted by heating, and a copper foil-PET substrate-copper foil laminate was prepared as a metal-foil-laminated resin film. The prepared metal-foil-laminated resin film was cut into a size of 600 mm×600 mm, a photosensitive film mask was then laminated on one surface of one of the two copper foils provided in the metal-foil-laminated resin film, and exposure patterning and a development treatment were performed. After the development, the copper foil was patterned with a metal etchant. Through the above-described steps, a total of 23 opening portions 15 (slits) having a length of 300 mm and a width W of 7 mm were provided in the copper foil such that the separated distance L (interval) between the opening portions 15 was 6 mm, and the electromagnetic wave shielding layer 11 was formed on the resin sheet 12. As a result, a high-frequency diffusion sheet 10 of sample No. 1C in which the electromagnetic wave reflection layer 13, the resin sheet 12, and the electromagnetic wave shielding layer 11 were laminated in this order was produced.

### (Sample No. 2C)

A copper foil-PET substrate-copper foil laminate was prepared as a metal-foil-laminated resin film by bonding a copper foil having an average thickness of 12 μm to each of both surfaces of a PET substrate (resin sheet 12) having an average thickness of 0.1 mm with an acrylic adhesive. The prepared metal-foil-laminated resin film was cut into a size of 600 mm×600 mm, a photosensitive film mask was then laminated on one surface of one of the two copper foils provided in the metal-foil-laminated resin film, and exposure patterning and a development treatment were performed. After the development, the copper foil was patterned with a metal etchant. Through the above-described steps, a total of 23 opening portions 15 (slits) having a length of 300 mm and a width W of 7 mm were provided in the copper foil such that the separated distance L (interval) between the opening portions 15 was 6 mm, and the electromagnetic wave shielding layer 11 was formed on the resin sheet 12. As a result, a high-frequency diffusion sheet 10 of sample No. 2C in which the electromagnetic wave reflection layer 13, the resin sheet 12, and the electromagnetic wave shielding layer 11 were laminated in this order was produced.

### (Sample No. 3C)

A PET substrate (resin sheet 12) having an average thickness of 0.1 mm was cut into a size of 600 mm×600 mm, and then copper vapor deposition was performed on both surfaces of the PET substrate to a thickness of 50 nm over the entire surface. Thereafter, a photosensitive film mask was laminated on one copper vapor-deposited surface, and exposure patterning and a development treatment were performed. After the development, a metal etching treatment was performed to remove the copper of the opening portions, thereby providing copper patterning. Thereafter, the photosensitive film was removed. Through the above-described steps, a total of 23 opening portions 15 (slits) having a length of 300 mm and a width W of 7 mm were provided such that the separated distance L (interval) between the opening portions 15 was 6 mm, and the electromagnetic wave shielding layer 11 was formed on the resin sheet 12. As a result, a high-frequency diffusion sheet 10 of sample No. 3C in which the electromagnetic wave reflection layer 13, the resin sheet 12, and the electromagnetic wave shielding layer 11 were laminated in this order was produced.

### (Sample No. 4C)

A PET substrate (resin sheet 12) having an average thickness of 0.1 mm was cut into a size of 600 mm×600 mm, and then a copper foil having a thickness of 50 nm was provided on one surface of the PET substrate by a copper vapor deposition treatment. Next, a photosensitive film mask was laminated on the other surface of the PET substrate, and exposure patterning and a development treatment were performed. After the development, a vapor deposition layer having a thickness of 50 nm was provided in the opening portions by a copper vapor deposition treatment. The photosensitive film was removed after the vapor deposition. Through the above-described steps, a total of 23 opening portions 15 (slits) having a length of 300 mm and a width W of 7 mm were provided such that the separated distance L (interval) between the opening portions 15 was 6 mm, and the electromagnetic wave shielding layer 11 was formed on the resin sheet 12. As a result, a high-frequency diffusion sheet 10 of sample No. 4C in which the electromagnetic wave reflection layer 13, the resin sheet 12, and the electromagnetic wave shielding layer 11 were laminated in this order was produced.

### (Sample No. 5C)

A PET substrate (resin sheet 12) having an average thickness of 0.1 mm was cut into a size of 600 mm×600 mm, and then aluminum vapor deposition was performed on both surfaces of the PET substrate over the entire surface at a thickness of 50 nm. Thereafter, a photosensitive film mask was laminated on one aluminum vapor-deposited surface, and exposure patterning and a development treatment were performed. After the development, a metal etching treatment was performed to remove the aluminum of the opening portions, thereby providing aluminum patterning. Thereafter, the photosensitive film was removed. Through the above-described steps, a total of 23 opening portions 15 (slits) having a length of 300 mm and a width W of 7 mm were provided such that the separated distance L (interval) between the opening portions 15 was 6 mm, and the electromagnetic wave shielding layer 11 was formed on the resin sheet 12. As a result, a high-frequency diffusion sheet 10 of sample No. 5C in which the electromagnetic wave reflection layer 13, the resin sheet 12, and the electromagnetic wave shielding layer 11 were laminated in this order was produced.

### (Sample No. 6C)

A PET substrate (resin sheet 12) having an average thickness of 0.1 mm was cut into a size of 600 mm×600 mm, and then aluminum vapor deposition was performed on both surfaces of the PET substrate over the entire surface at a thickness of 50 nm. Thereafter, a photosensitive film mask was laminated on one aluminum vapor-deposited surface, and exposure patterning and a development treatment were performed. After the development, a metal etching treatment was performed to remove the aluminum of the opening portions, thereby providing aluminum patterning. Thereafter, the photosensitive film was removed. Through the above-described steps, a total of 23 opening portions 15 (slits) having a length of 300 mm and a width W of 7 mm were provided such that the separated distance L (interval) between the opening portions 15 was 6 mm. Further, the electromagnetic wave shielding layer 11 in which the through-holes 16 having a square shape with a width Wh of 250 μm were formed at a separated distance Lh of 50 μm from each other in a region where the opening portions 15 of the electromagnetic wave shielding layer 11 were not formed was formed on one surface of the resin sheet 12. Then, the electromagnetic wave reflection layer 13 in which the through-holes 16 having a square shape with a width Wh of 250 μm were formed on the entire surface of the other aluminum vapor-deposited surface at a separated distance Lh of 50 μm was formed on the other surface of the resin sheet 12. In this manner, a high-frequency diffusion sheet 10 of sample No. 6C was produced.

### (Sample Nos. 7C to 11C)

High-frequency diffusion sheets 10 of sample Nos. 7C to 11C were produced in the same manner as in the above-mentioned sample No. 6C except that at least one of the width W of the opening portions 15, the separated distance L between the opening portions 15, and the number of the opening portions 15 was changed as shown in Table 3.

### (Sample No. 12C)

A high-frequency diffusion sheet 10 of sample No. 12C was produced in the same manner as in the above-mentioned sample No. 5C except that the width W, the separated distance L, and the number of the opening portions 15 were changed as shown in Table 3.

### (Sample No. 13C)

An aluminum foil-PET substrate-aluminum foil laminate was prepared as a metal-foil-laminated resin film by bonding an aluminum foil having an average thickness of 12 μm to each of both surfaces of a PET substrate (resin sheet 12) having an average thickness of 0.1 mm with an acrylic adhesive. The prepared metal-foil-laminated resin film was cut into a size of 600 mm×600 mm, a photosensitive film mask was then laminated on one surface of one of the two aluminum foils provided in the metal-foil-laminated resin film, and exposure patterning and a development treatment were performed. After the development, the aluminum foil was patterned with a metal etchant, and a total of 10 aluminum foils were provided with opening portions 15 (slits) having a length of 90 mm and a width W of 5 mm such that the separated distance L (interval) was 5 mm, and thus the electromagnetic wave shielding layer 11 was formed on the resin sheet 12. As a result, a high-frequency diffusion sheet 10 of sample No. 13C in which the electromagnetic wave reflection layer 13, the resin sheet 12, and the electromagnetic wave shielding layer 11 were laminated in this order was produced.

### (Sample No. 14C)

A high-frequency diffusion sheet 10 of sample No. 14C was produced in the same manner as in the above-mentioned sample No. 1C except that the opening portions 15 were not formed.

### (Sample No. 15C)

A PET substrate (resin sheet 12) having an average thickness of 0.1 mm was cut into a size of 600 mm×600 mm, and then a Ni layer having a thickness of 50 nm was provided on one surface of the PET substrate by a Ni vapor deposition treatment. Next, a photosensitive film mask was laminated on the other surface of the PET substrate, and exposure patterning and a development treatment were performed. After development, a vapor deposition layer having a thickness of 50 nm was provided by a Ni vapor deposition treatment in the photosensitive film mask opening portions, and then the photosensitive film was removed. Through the above-described steps, a total of 23 opening portions 15 (slits) having a length of 300 mm and a width W of 7 mm were provided such that the separated distance L (interval) between the opening portions 15 was 6 mm, and thus the electromagnetic wave shielding layer 11 was formed on the resin sheet 12. As a result, a high-frequency diffusion sheet 10 of sample No. 15C in which the electromagnetic wave reflection layer 13, the resin sheet 12, and the electromagnetic wave shielding layer 11 were laminated in this order was produced.

### 3-3. Evaluation

### <Confirmation of Diffuseness of Electromagnetic Waves>

<1C> First, the high-frequency diffusion sheets 10 of each of the sample numbers were mounted on the frame 100 so as to correspond to the opening portions provided in the frame 100, thereby obtaining a test sample 150 for confirming diffraction of electromagnetic waves (refer to FIGS. 6A and 6B).
<2C> Subsequently, as shown in FIGS. 6A and 6B, the receiver 20 was disposed such that the receiver was 10 mm inward in the plane direction from the end portion of the frame 100, and the separated distance in the thickness direction from the frame 100 was 10 mm.
<3C> Subsequently, electromagnetic waves (plane waves) with a frequency shown in Table 3 were incident on the high-frequency diffusion sheets 10 of each of the sample numbers from the surface of the test sample 150 on which the receiver 20 was disposed. Thereafter, the electromagnetic waves reflected by the high-frequency diffusion sheet 10 were received using the receiver 20. Then, the presence or absence of diffraction (diffusion) of the electromagnetic waves by the high-frequency diffusion sheet 10 was evaluated based on the following evaluation criteria.

### Evaluation Criteria

A: the electromagnetic waves could be clearly received by the receiver 20.
B: the electromagnetic waves could be sufficiently received by the receiver 20 although the reception could not be said to be clear.
C: the electromagnetic waves could be received by the receiver 20 although the reception intensity could not be said to be sufficient.
D: the reception intensity was an intensity that could not be said that the electromagnetic waves could be received by the receiver 20.

### <Confirmation of Transmittance of Visible Light>

For the high-frequency diffusion sheets 10 of each of the sample numbers, the light transmittance (%) of visible light at a wavelength of equal to or more than 300 nm and equal to or less than 800 nm was measured using an ultraviolet-visible spectrophotometer (“UV-2600i” manufactured by Shimadzu Corporation). Then, the presence or absence of transmission of visible light by the high-frequency diffusion sheet 10 was evaluated based on the following evaluation criteria.

### Evaluation Criteria

The light transmittance of visible light at a wavelength of equal to or more than 300 nm and equal to or less than 800 nm was as follows.
A: equal to or more than 70%.
B: equal to or more than 50% and less than 70%.
C: less than 50%.

Table 3 below shows each of the evaluation results obtained as described above.

TABLE 3

| | | | | | | | | | | | | | | | | Comparative |
|---|---|---|---|---|---|---|---|---|---|---|---|---|---|---|---|---|
| | | Example | | | | | | | | | | | | | | Example |
| | | Sample No. | | | | | | | | | | | | | | |
| | | 1C | 2C | 3C | 4C | 5C | 6C | 7C | 8C | 9C | 10C | 11C | 12C | 13C | 15C | 14C |
| Material of | Copper | ∘ | ∘ | ∘ | ∘ | | | | | | | | | | | ∘ |
| electromagnetic | Aluminum | | | | | ∘ | ∘ | ∘ | ∘ | ∘ | ∘ | ∘ | ∘ | ∘ | | — |
| wave shielding | Ni | | | | | | | | | | | | | | ∘ | |
| layer 11 | | | | | | | | | | | | | | | | |
| Method of | Fusion | ∘ | | | | | | | | | | | | | | — |
| forming | Adhesion | | ∘ | | | | | | | | | | | ∘ | | — |
| electromagnetic | Vapor | | | ∘ | ∘ | ∘ | ∘ | ∘ | ∘ | ∘ | ∘ | ∘ | ∘ | | ∘ | — |
| wave shielding | deposition | | | | | | | | | | | | | | | |
| layer 11 on | | | | | | | | | | | | | | | | |
| resin film 12 | | | | | | | | | | | | | | | | |
| Method of | Etching | ∘ | ∘ | ∘ | | ∘ | ∘ | ∘ | ∘ | ∘ | ∘ | ∘ | ∘ | ∘ | | |
| forming | Vapor | | | | ∘ | | | | | | | | | | ∘ | — |
| opening | deposition | | | | | | | | | | | | | | | |
| portions | patterning | | | | | | | | | | | | | | | |
| Frequency (GHz) of | | 28 | 28 | 28 | 28 | 28 | 28 | 28 | 28 | 28 | 28 | 28 | 4 | 28 | 28 | |
| electromagnetic | | | | | | | | | | | | | | | | |
| waves (plane waves) | | | | | | | | | | | | | | | | |
| Opening | Shape | Rectangular shape | | | | | | | | | | | | | | Not formed |
| portion 15 | Length (mm) | 300 | 300 | 300 | 300 | 300 | 300 | 300 | 300 | 300 | 300 | 300 | 300 | 90 | 300 | — |
| | Width W (mm) | 7 | 7 | 7 | 7 | 7 | 7 | 5 | 7 | 5 | 10 | 10 | 49 | 5 | 7 | — |
| | Separated | 6 | 6 | 6 | 6 | 6 | 6 | 6 | 10 | 10 | 6 | 10 | 42 | 5 | 6 | — |
| | distance | | | | | | | | | | | | | | | |
| | L (mm) | | | | | | | | | | | | | | | |
| | (Relationship | 0.7 | 0.7 | 0.7 | 0.7 | 0.7 | 0.7 | 0.5 | 0.7 | 0.5 | 1 | 1 | 0.7 | 0.5 | 0.7 | — |
| | W/A between | | | | | | | | | | | | | | | |
| | separated | | | | | | | | | | | | | | | |
| | distance W | | | | | | | | | | | | | | | |
| | and A) | | | | | | | | | | | | | | | |
| | (Relationship | 0.6 | 0.6 | 0.6 | 0.6 | 0.6 | 0.6 | 0.6 | 1 | 1 | 0.6 | 1 | 0.6 | 0.5 | 0.6 | — |
| | L/A between | | | | | | | | | | | | | | | |
| | separated | | | | | | | | | | | | | | | |
| | distance L | | | | | | | | | | | | | | | |
| | and A) | | | | | | | | | | | | | | | |
| | Number of | 23 | 23 | 23 | 23 | 23 | 23 | 27 | 18 | 20 | 19 | 15 | 3 | 10 | 23 | — |
| | opening | | | | | | | | | | | | | | | |
| | portions | | | | | | | | | | | | | | | |
| Evaluation | Diffuseness of | A | A | A | A | A | A | B | B | C | B | C | A | B | A | D |
| | electromagnetic | | | | | | | | | | | | | | | |
| | waves | | | | | | | | | | | | | | | |
| | Presence or | C | C | C | C | C | A | A | A | A | A | A | C | C | A | C |
| | absence of | | | | | | | | | | | | | | | |
| | transmission of | | | | | | | | | | | | | | | |
| | visible light | | | | | | | | | | | | | | | |

As shown in Table 3, the results show that since the electromagnetic wave shielding layer 11 provided in the high-frequency diffusion sheet 10 had the opening portions 15 penetrating the electromagnetic wave shielding layer 11 in the thickness direction, the electromagnetic waves were diffused by being diffracted by the opening portions 15 of the electromagnetic wave shielding layer 11 when the electromagnetic waves were reflected by the high-frequency diffusion sheet 10. Further, it became clear that the electromagnetic waves could be diffused with better diffuseness by setting the width W of the opening portions 15 to be smaller than the wavelength of the electromagnetic waves and by appropriately setting the separated distance L between the opening portions 15.

In addition, it became clear that, in a case where the through-holes 16 were formed in the region of the electromagnetic wave shielding layer 11 where the opening portions 15 were not formed and the entire region of the electromagnetic wave reflection layer 13, the transmittance of visible light could be imparted to the high-frequency diffusion sheet 10.

### 4. Examination of Transmittance of Visible Light and Electromagnetic Wave Shielding Properties

### 4-1. Production of Electromagnetic Wave Reflection Sheet

### (Sample No. 1D)

A copper foil having an average thickness of 12 μm was laminated on one surface of the PET substrate (resin sheet 12) melted by heating, and a copper foil-PET substrate laminate was prepared as a metal-foil-laminated resin film. The prepared metal-foil-laminated resin film was cut into a size of 600 mm×600 mm, a photosensitive film mask was then laminated on the copper foil surface of the metal-foil-laminated resin film, and exposure patterning and a development treatment were performed. After the development, the copper foil was patterned with a metal etchant. Through the above-described steps, the electromagnetic wave reflection layer 13 in which the through-holes 16 having a length of 500 μm and a width W of 500 μm were formed on the resin sheet 12 at a separated distance Lh (interval) of 20 μm was formed. In this case, the opening ratio of the electromagnetic wave reflection layer was 92%. As a result, an electromagnetic wave shielding sheet of sample No. 1D in which the electromagnetic wave reflection layer 13 and the resin sheet 12 were laminated was produced.

### (Sample Nos. 2D to 11D)

Electromagnetic wave reflective sheets of samples 2D to 11D were produced using the same method as in the above-mentioned sample No. 1D except that the length, width, and separated distance L (interval) of the through-holes 16 formed in the copper foil were changed as shown in Table 4.

### <Confirmation of Transmittance of Visible Light>

For the electromagnetic wave reflection sheets of each of the sample numbers, the light transmittance (%) of visible light at a wavelength of equal to or more than 300 nm and equal to or less than 800 nm was measured using an ultraviolet-visible spectrophotometer (“UV-2600i” manufactured by Shimadzu Corporation). The presence or absence of transmission of visible light by the electromagnetic wave reflecting sheet was evaluated based on the evaluation standards shown below.

### Evaluation Criteria

The light transmittance of visible light at a wavelength of equal to or more than 300 nm and equal to or less than 800 nm was as follows.
A: equal to or more than 80%.
B: equal to or more than 60% and less than 70%.
C: less than 60%.

Table 4 below shows each of the evaluation results obtained as described above.

### <Confirmation of Electromagnetic Wave Shielding Properties>

A frame configured from an aluminum plate was prepared (outer shape: 700 mm×700 mm, opening portion: 500 mm×500 mm). A 500 mm square high-frequency diffusion film material prepared was disposed in the center portion. In addition, the radio wave receiver and the transmitter were fixed at the positions separated by 3 m, and the high-frequency diffusion film was installed at the position separated by 600 mm from the transmitter. In that state, a millimeter wave of 28 GHz was transmitted from the transmitter, and the radio wave intensity was measured by the receiver to calculate the electromagnetic wave shielding properties.

The electromagnetic wave shielding properties of the PET alone were −35 dB.

### Evaluation Criteria

A: equal to or more than 5 dB lower than the electromagnetic wave shielding properties of the PET alone.
B: 3 to 5 dB lower than the electromagnetic wave shielding properties of the PET alone.
C: within 3 dB of the electromagnetic wave shielding properties of the PET alone.

Table 4 below shows each of the evaluation results obtained as described above.

TABLE 4

| | | Example | | | | | | | Comparative Example | | |
|---|---|---|---|---|---|---|---|---|---|---|---|
| | | Sample No. | | | | | | | Sample No. | | |
| | | 1D | 2D | 3D | 4D | 5D | 7D | 8D | 9D | 10D | 11D |
| Through-hole porosity | [%] | 92 | 89 | 86 | 83 | 80 | 91 | 83 | 95 | 97 | 78 |
| Width of through-hole | [um] | 500 | 500 | 500 | 500 | 500 | 1000 | 1000 | 2000 | 3000 | 1000 |
| Length of through-hole | [um] | 500 | 500 | 500 | 500 | 500 | 1000 | 1000 | 500 | 500 | 1000 |
| Separated distance | [um] | 20 | 30 | 40 | 50 | 60 | 50 | 100 | 20 | 10 | 130 |
| Visible light | [%] | 82 | 78 | 76 | 73 | 70 | 80 | 73 | 84 | 85 | 69 |
| transmittance | Determination | A | B | B | B | B | A | B | A | A | C |
| Radio wave shielding | [dB] | −40 | −41 | −41 | −42 | −48 | −39 | −41 | −36 | −35 | −43 |
| properties (28 GHz | Determination | B | A | A | A | A | B | A | C | C | A |

As shown in Table 4, it became clear that since the electromagnetic wave reflection layer 13 provided in the electromagnetic wave reflection sheet had the through-hole 16 having a predetermined width, a predetermined length, and a predetermined separated distance between the through-holes 16 in the thickness direction, the transmittance of visible light and the electromagnetic wave shielding properties could be imparted to the electromagnetic wave reflection layer 13.

### INDUSTRIAL APPLICABILITY

According to the high-frequency diffusion sheet of the present invention, when electromagnetic waves in a high frequency range are reflected, the electromagnetic waves can be reliably diffused by being diffracted in the opening portion of the electromagnetic wave shielding layer of the high-frequency diffusion sheet. Therefore, in a case where electromagnetic waves are received by a communication device inside a building (building structure), the high-frequency diffusion sheet according to the present invention is attached to a wall portion or the like of the building before the electromagnetic waves in the high frequency range are transmitted through a transmission region through which the electromagnetic waves are allowed to be transmitted, such as a window portion provided in the building. As a result, since the electromagnetic waves are reflected and diffused, that is, diffracted, without being absorbed by colliding with the wall portion or the like, the electromagnetic waves have another opportunity to pass through the passage region. Further, after the electromagnetic waves in the high frequency range are transmitted through the transmission region and are introduced into the building, the high-frequency diffusion sheet according to the present invention is attached to the wall portions, the curtains, or the like in the building. As a result, in these wall portions, curtains, and the like, the electromagnetic waves can be reflected and diffused, that is, diffracted. Therefore, the electromagnetic waves can be favorably received by the communication device in a wide range inside the building. Accordingly, the present invention has industrial applicability.

### REFERENCE SIGNS LIST

10: high-frequency diffusion sheet
11: electromagnetic wave shielding layer
12: resin sheet
13: electromagnetic wave reflection layer
14: protective layer
15: opening portion
16: through-hole
20: receiver
100: frame
150: test sample
D: diameter
L: separated distance
Lh: separated distance
T1: average thickness
T2: average thickness
W: width
Wh: width
WA: plane wave

1. A high-frequency diffusion sheet that is used for diffusing electromagnetic waves in a high frequency range, the high-frequency diffusion sheet comprising:
a laminate having an electromagnetic wave shielding layer that has electromagnetic wave shielding properties, and an electromagnetic wave reflection layer that is laminated on the electromagnetic wave shielding layer and has electromagnetic wave reflectivity,
wherein the electromagnetic wave shielding layer is patterned in a plan view of the laminate and has an opening portion penetrating the electromagnetic wave shielding layer in a thickness direction.

2. The high-frequency diffusion sheet according to claim 1,
wherein the electromagnetic wave shielding layer shields the electromagnetic waves by reflecting or absorbing the electromagnetic waves.

3. The high-frequency diffusion sheet according to claim 2,
wherein both the electromagnetic wave shielding layer and the electromagnetic wave reflection layer are thin metal film layers or metal powder-containing adhesive layers configured to contain a metal powder and a binder resin.

4. The high-frequency diffusion sheet according to claim 1,
wherein the laminate further has a resin sheet having transparency, and the resin sheet is laminated between the electromagnetic wave shielding layer and the electromagnetic wave reflection layer, on a side of the electromagnetic wave shielding layer opposite to the electromagnetic wave reflection layer, or on a side of the electromagnetic wave reflection layer opposite to the electromagnetic wave shielding layer.

5. The high-frequency diffusion sheet according to claim 1,
wherein the high-frequency diffusion sheet is configured such that the electromagnetic waves are diffused by being diffracted by the opening portion when the electromagnetic waves reflected by the electromagnetic wave reflection layer pass through the electromagnetic wave shielding layer.

6. The high-frequency diffusion sheet according to claim 1,
wherein when an average width of the opening portion is W [mm] and a wavelength of the electromagnetic waves is λ [mm], W/λ is equal to or less than 1.0.

7. The high-frequency diffusion sheet according to claim 1,
wherein an average thickness T1 of the electromagnetic wave shielding layer is equal to or more than 0.05 μm and equal or less than 70.0 μm.

8. The high-frequency diffusion sheet according to claim 1,
wherein an average thickness T2 of the electromagnetic wave reflection layer is equal to or more than 0.05 μm and equal or less than 70.0 μm.

9. The high-frequency diffusion sheet according to claim 1,
wherein a frequency of the electromagnetic waves is equal to or more than 1 GHz and equal to or less than 80 GHz.

10. The high-frequency diffusion sheet according to claim 1,
wherein the high-frequency diffusion sheet is used by being attached to at least one of an inside and an outside of a building.

11. The high-frequency diffusion sheet according to claim 1,
wherein the electromagnetic wave reflection layer has a plurality of through-holes penetrating the electromagnetic wave reflection layer in a thickness direction, and
an opening ratio of the electromagnetic wave reflection layer is 80% to 95%.

12. The high-frequency diffusion sheet according to claim 11,
wherein when a wavelength of the electromagnetic waves is λ [mm], a width of the through-hole is equal to or less than λ/10 [mm].
